(19) United States
(12) Patent Application Publication
(10) Pub. No.: US 2014/0176582 A1
(43) Pub. Date: Jun. 26, 2014

(54) DEVICE AND METHOD FOR CONTROLLING A COCKPIT DISPLAY BY PARTITIONING

(71) Applicant: ECE, Paris (FR)

(72) Inventors: Rémy ANDREOLETTI, CHELLES (FR); Vianney POUGET, VINCENNES (FR)

(21) Appl. No.: 14/133,237

(22) Filed: Dec. 18, 2013

(30) Foreign Application Priority Data
Dec. 21, 2012 (FR) 1262654

(51) Int. Cl. G09G 5/00

(52) U.S. Cl. CPC G09G 5/006
USPC 345/520

(57) ABSTRACT

A display control device for a cockpit allows for a time-oriented graphics partitioning. The device comprises a reception module for receiving a display request for a graphics service during the execution of a sequence of partitions, a configuration module for defining the duration of the sequence, the order and the duration of each partition, and a control module for determining whether the remaining execution time of the partition on which the graphics service depends is or is not sufficient to execute the graphics service. The graphics service is executed or stopped according to remaining computer time.

### CROSS-REFERENCE TO RELATED APPLICATION

This application claims priority to foreign French patent application No. FR 1262654, filed on Dec. 21, 2012, the disclosure of which is incorporated by reference in its entirety.

### FIELD OF THE INVENTION

The invention relates to the field of aeronautics and in particular that of the cockpit control and display systems.

### BACKGROUND

The main centralized interface supplying display and control functions in a modern aeroplane cockpit is known as an “all-screen instrument panel”, or “Control and Display System” (CDS). This system is made up of computers, individually called “Display Units”, or (DU), that can each incorporate or be coupled to a graphics computation unit, called “Graphical Processing Unit” or (GPU), intended to ensure the display capabilities of the DU.

Generally, the GPU used for the DUs originates from general consumer components, such as “Commercial Off-The-Shelf” or (COTS) components. These components are not, however, by nature intended to process data in real time, which is the requirement for the display in the cockpits. Having a de facto fixed design, certain mechanisms of the COTS GPUs are deactivated to ensure a deterministic behaviour of the systems. Moreover, there are limitations on certain functionalities, such as the graphics partitioning.

The computers DUs potentially host a number of partitions. A partition, or more generally the partitioning, is the function which covers the mechanism making it possible to separate portions of a system by leaving sufficient independence/isolation between the portions or partitions so as to allow development assurance levels (DAL) for each partition. The partitioning makes it possible to reduce the efforts required for the system verification procedures.

When a partition changes, an impact analysis is systematically carried out. In practice, the design of the computers does not necessarily guarantee that the impacts of a change remain contained in the partition concerned. If a partition starts to behave incorrectly, it can, on the graphical layer, preempt the execution of graphical symbols of the other partitions, possibly going as far as their loss. The impact analysis carries out so-called “non-regression” tests. Now such tests are tedious, potentially lasting several months, which has a not inconsiderable impact on the overall cost.

Thus, with the known solutions presenting the abovementioned drawbacks, there is the need for a solution which overcomes the existing limitations by proposing a novel device and an associated method for controlling the graphics display for a cockpit.

### SUMMARY OF THE INVENTION

The subject of the present invention is a device for monitoring and controlling the execution of graphics services of partitions of a display unit (DU) in a graphics processing unit (GPU).

The invention makes it possible to improve the isolation and the independence between partitions in an embedded graphics processing unit GPU.

Advantageously, the present invention contributes to limiting, reducing or even eliminating the non-regression analyses and tests in the event of a change to a partition.

Again advantageously, the present invention improves the dependability of the ‘CDS’ systems.

The present invention applies advantageously to the control and display systems of the aeroplane cockpits, but it is also applicable to any critical display environment.

Thus, the subject of the invention is a display control device comprising:
a reception module for receiving at least one display request for at least one graphics service during the execution of the sequence of a plurality of partitions;
a configuration module coupled to the request reception module for defining the duration of the sequence, the order and the duration of each partition; and
a control module coupled to the configuration module to determine whether the remaining execution time of the partition on which said at least one graphics service depends is or is not sufficient to execute said at least one graphics service.

In a particular aspect of the invention, the device comprises a counter for counting the execution time of said sequence.

In a particular aspect of the invention, the control module comprises a time monitoring module for determining the partition currently being executed on receipt of said at least one display request.

In a particular aspect of the invention, the time monitoring module comprises means for computing the time remaining before the end of the execution of the partition currently being executed.

In a particular aspect of the invention, the device also comprises means for stopping the execution of the graphics service.

Advantageously, the functions of the control module are implemented by a computer program.

In a particular aspect of the invention, the reception module is coupled to a central processing unit ‘CPU’ for receiving the display requests for said at least one graphics service.

In a particular aspect of the invention, the central processing unit executes a sequence of the plurality of partitions in the same order but with the partition times being able to be different.

In a particular implementation, the subject of the invention is a graphics processing unit ‘GPU’ for a cockpit which comprises the control and display device in all its variants.

Another subject of the invention is a graphics display control method for a cockpit that is executed in a graphics processing unit ‘GPU’ which comprises the steps of:
receiving a display request for at least one graphics service during the execution of a sequence of a plurality of partitions, each partition having a defined execution time;
identifying the partition on which the graphics service depends;
computing the remaining execution time of the identified partition;
determining whether the remaining execution time is sufficient to execute said at least one graphics service; and
executing said at least one graphics service or stopping it.

Also a subject of the invention is a “Display Unit” (DU) qui which comprises the display control device according to the invention.

### BRIEF DESCRIPTION OF THE DRAWINGS

Other features and advantages of the invention will become apparent using the following description, given in light of the appended drawings which represent:

FIG. 1, an example of association of graphics overlays with partitions;

FIG. 2, a schematic representation of the device of the invention;

FIG. 3, an example of partition sequencing according to the principles of the invention; and

FIG. 4, a flow diagram of the control method according to the principles of the invention.

### DETAILED DESCRIPTION

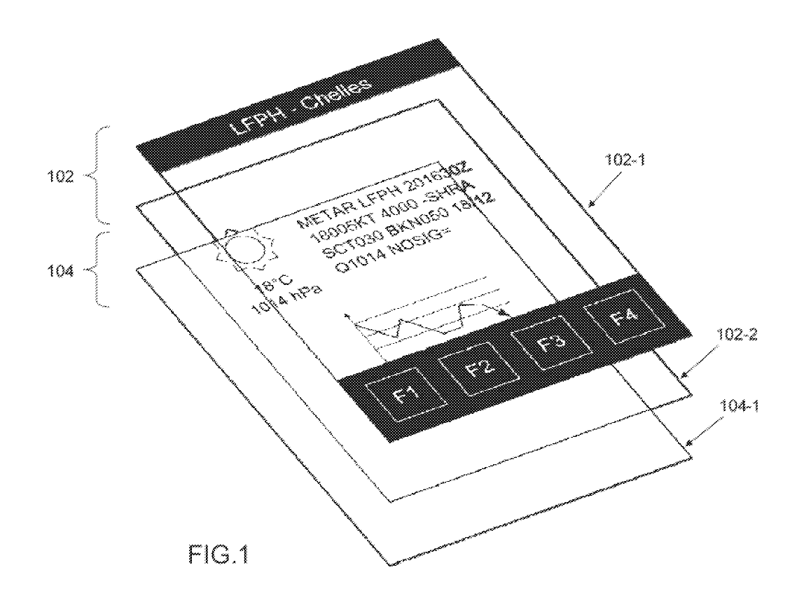

FIG. 1 shows, in a simplified example, an association of graphics overlays for partitions. Each graphics overlay makes it possible to display data relating a graphics service which is requested during the execution of the partition on which it depends.

Two graphics overlays (102-1, 102-2) are associated with a first partition 102, meaning that, during the execution of the first partition, a computation relating to the information to be displayed for the first overlay (102-1) is performed to then make it possible to display this information. Then, a computation relating to the information of the second overlay (102-2) is performed to allow the corresponding data to be displayed.

Similarly, an overlay (104-1) is associated with a second partition 104 and its content will be computed and displayed during the execution of the second partition.

A person skilled in the art will understand that the example shown is simplified to allow for a good understanding of the principles of the invention, but that this illustrative example is in no way limiting both on the number of overlays per partition, and on the number of partitions themselves.

If, during the execution of a partition, an incorrect or unexpected behaviour occurs, thereby extending the execution time of the partition in the graphics processing unit (GPU), the device of the invention as described in detail below makes it possible to stop this execution and to maintain the time allotted for the execution of subsequent partitions.

By incorrect or unexpected behaviour, a person skilled in the art will understand that it can be requests to access an unauthorized graphics service or to access an authorized service but one that contains forbidden properties or even to access an authorized service requested at an unauthorized moment.

Advantageously, the control device of the invention makes it possible to ensure a maximum execution time for each overlay beyond which the execution is stopped, either normally, or by being forced by the device of the invention.

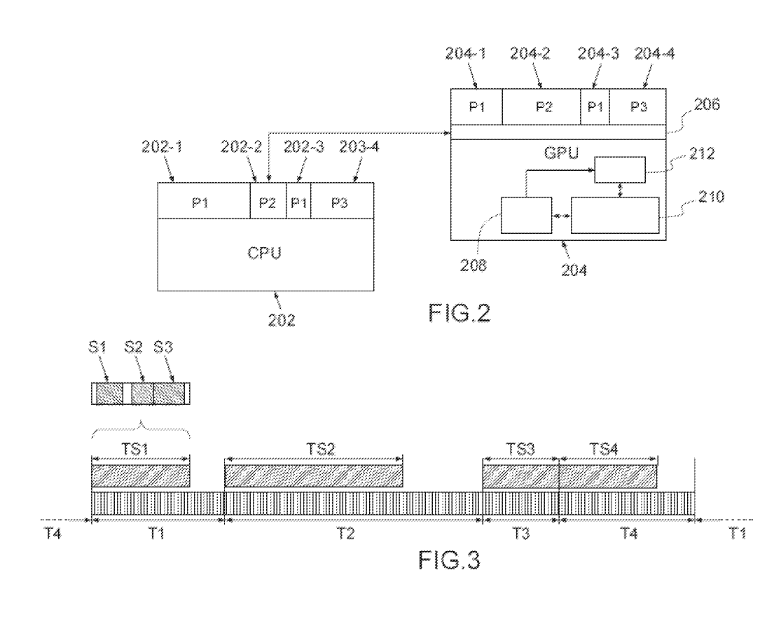

FIG. 2 shows a schematic representation of the device of the invention. A computer comprises a CPU module (202) which can execute a plurality of partitions (202-1, 202-2, 202-3, 202-4) according to a given scheduling (P1, P2, P1, P3).

The CPU unit is coupled to a dedicated computation unit or GPU (204) which receives display commands (or graphics services) for the different partitions of the CPU.

Within the GPU, a scheduling module (206) makes it possible to execute the display functions. The GPU also comprises a configuration table (208) coupled to a monitoring module (210) and to a counter (212).

Preferentially, the configuration table is a static table whose content is loaded when the computer is started up. It defines at least:
the top-level or referring sequence (“Frame”), which sets the order of the partitions in the sequences to be executed. In the example chosen, the order of the partitions (204-1, 204-2, 204-3, 204-4) is (P1, P2, P1, P3);
the theoretical maximum execution time of each partition during the sequence; and
the maximum duration of each graphics service which will be able to be called by a partition, this time also being called “Worst Case Execution Time” or (WCET).

Although not illustrated in the figure, the GPU is coupled to conventional means to allow for the display of the requested graphics services.

It should be noted that the order of the partitions in the GPU is identical to that in the CPU but that the execution time of each partition may differ.

The operational principle of the device of the invention is now described with reference to FIG. 3 which shows a sequence of execution of four partitions.

A first partition (204-1) is executed for a theoretical maximum time of T1=10 000 microseconds. The second partition (204-2) is executed over a theoretical maximum time of T2=20 000 microseconds. The third partition (204-3) has a maximum execution time of T3=5000 microseconds and the fourth partition (204-4) has a maximum execution time of T4=10 000 microseconds.

Thus, the top-level sequence has a total value ‘T’ of (T1+T2+T3+T4=45 000 microseconds) for the example chosen. This value is stored in the configuration table (208). When the GPU is started up, the counter (212) of the GPU is set to the total value and begins the countdown of the execution time.

Each partition itself has a time slice which is allotted to it for the execution of the corresponding graphics service or services. Thus, respectively for the partitions 204-1 to 204-4, the service time is (TS1, TS2, TS3, TS4).

During the execution of a partition, the requested graphics services are executed, such as, for example, the services S1, S2 and S3, for the time TS1.

From the information in the configuration table (208) and the value of the counter (212) at an instant ‘t’, the time monitoring unit (210) of the GPU checks that, for each graphics service which is called during the time slice of a partition, there is sufficient time remaining for the execution of the partition before the change to the next partition. If the remaining time is not sufficient, the execution of the service is stopped and the display of the incorrect partition is disabled.

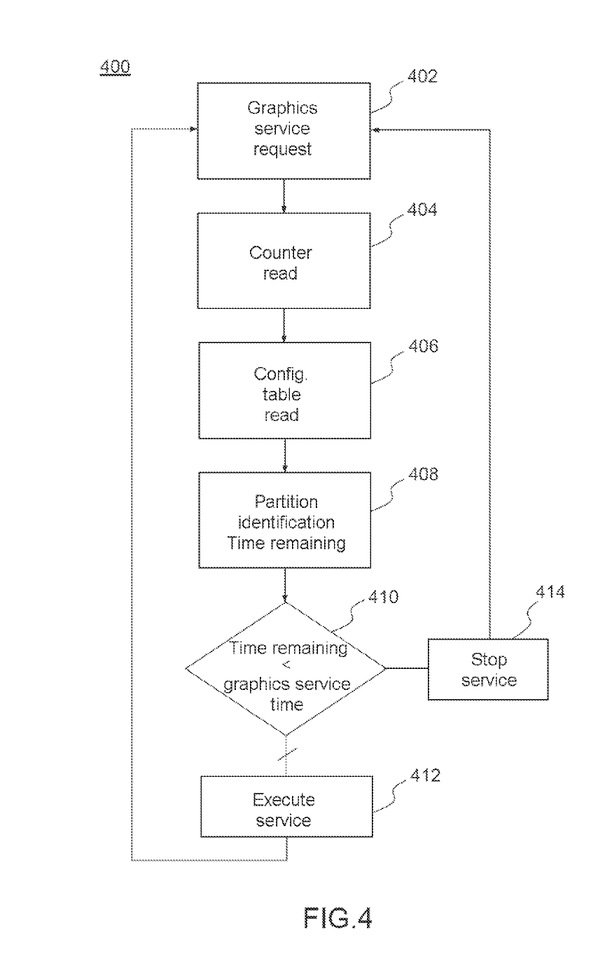

The method (400) applied in the GPU by the device of the invention is described with reference to FIG. 4, by taking the values of the sequence of FIG. 3 as an example.

The method begins for each sequence, when a graphics service request is detected (402) during the execution of a partition. For example a request for a graphics service having a required service time of 600 microseconds is received at 500 microseconds before the end of the execution of the third partition (204-3).

The method makes it possible, in a subsequent step (404), to read the current value of the counter (212): the counter which counts down from the beginning of the sequence is here equal to 10 500 microseconds, that is to say the total value of the sequence (45 000 microseconds) minus the time already elapsed, equal to (10 000+20 000+4500=34 500 microseconds).

Then, in a subsequent step (406), the method makes it possible to recover in the configuration table (208), the information relating to the current sequence, in particular the sequencing of the partitions (P1, P2, P1, P3), the duration of each partition (TS1, TS2, TS3, TS4) and the time remaining before the end of the sequence (i.e., here, 10 500 microseconds).

In the next step (408), based on the information read in the table and on the value of the counter, the method makes it possible to determine which is the partition currently being executed (here, the partition 204-3), then to compute the time remaining before the end of the execution of this partition (here, 500 microseconds).

In a subsequent step (410), the method compares the value of the computed remaining time against the maximum execution time of the service called (i.e. 500 microseconds compared to 600 microseconds).

If the time remaining is greater than the maximum execution time of the service, then, in the next step (412), the service is executed.

If the time remaining is less than the maximum execution time of the service, then the execution is stopped (414).

Then, the method returns to the initial step (402) until the running of the sequence ends.

Thus, the present description illustrates a preferential implementation of the invention, but it is not limiting. An example has been chosen to allow for a good understanding of the principles of the invention, and a concrete application, but it is in no way exhaustive and should allow a person skilled in the art to add modifications and variant implementations while keeping the same principles. The present invention can be implemented on the basis of hardware and/or software elements.

1. A display control device for a graphics processing unit, comprising:
a reception module for receiving at least one display request for at least one graphics service during the execution of a sequence of a plurality of partitions;
a configuration module coupled to the request reception module for defining the duration of the sequence, the order and the duration of each partition; and
a control module coupled to the configuration module to determine whether the remaining execution time of the partition on which said at least one graphics service depends is or is not sufficient to execute said at least one graphics service.

2. The device according to claim 1, in which the control module comprises a counter for counting the execution time of said sequence.

3. The device according to claim 1, in which the control module comprises a time monitoring module for determining the partition currently being executed on reception of said at least one display request.

4. The device according to claim 3, in which the time monitoring module comprises means for computing the time remaining before the end of the execution of the partition currently being executed.

5. The device according to claim 1, further comprising means for stopping the execution of the graphics service.

6. The device according to claim 1, in which the functions of the control module are implemented by a computer program.

7. The device according to claim 1, in which the reception module is coupled to a central processing unit for receiving the display requests for said at least one graphics service.

8. The device according to claim 7, in which the central processing unit executes a sequence of the plurality of partitions in the same order but with the partition times being able to be different.

9. A cockpit comprising the device according to claim 1.

10. A display control method for a cockpit, the method being executed in a graphics processing unit and comprising the steps of:
receiving a display request for at least one graphics service during the execution of a sequence of a plurality of partitions, each partition having a defined execution time;
identifying the partition on which the graphics service depends;
computing the remaining execution time of the identified partition;
determining whether the remaining execution time is sufficient to execute said at least one graphics service; and
executing said at least one graphics service or stopping it.
